(19) United States
(12) Patent Application Publication
(10) Pub. No.: US 2022/0209951 A1
(43) Pub. Date: Jun. 30, 2022

(54) AUTHENTICATION METHOD, APPARATUS AND DEVICE, AND COMPUTER-READABLE STORAGE MEDIUM

(71) Applicant: BEIJING SENSETIME TECHNOLOGY DEVELOPMENT CO., LTD., Beijing (CN)

(72) Inventors: Junchen DONG, Beijing (CN); Daiping ZHAO, Beijing (CN); Huafu OU, Beijing (CN); Yuwen SUO, Beijing (CN); Qiuyuan WANG, Beijing (CN)

(73) Assignee: BEIJING SENSETIME TECHNOLOGY DEVELOPMENT CO., LTD., Beijing (CN)

(21) Appl. No.: 17/650,677

(22) Filed: Feb. 11, 2022

Related U.S. Application Data
(63) Continuation of application No. PCT/CN2021/089440, filed on Apr. 23, 2021.

(30) Foreign Application Priority Data
Aug. 31, 2020 (CN) 202010898310.5

(51) Int. Cl. H04L 9/32

(52) U.S. Cl. CPC H04L 9/32

(57) ABSTRACT

An authentication method includes: information to be verified is encrypted according to a first time stamp to obtain a first ciphertext; an authentication request carrying the first ciphertext and the first time stamp is sent to a server; an authentication response corresponding to the authentication request and sent by the server is received, the authentication response carrying a second ciphertext and a second time stamp; and the second ciphertext is decrypted according to the second time stamp to obtain an authentication result of authenticating the information to be verified by the server.

### CROSS-REFERENCE TO RELATED APPLICATIONS

This is a continuation of International Application No. PCT/CN2021/089440 filed on Apr. 23, 2021, which claims priority to Chinese Patent Application No. 202010898310.5 filed on Aug. 31, 2020. The disclosures of these applications are hereby incorporated by reference in their entirety.

### BACKGROUND

With the popularization of Internet technology and the increasing complexity of network services, an operating mode in the conventional art of putting all computing tasks in a server causes the server to become increasingly overloaded. To solve the above problem, administrators of the network services may put part or all of the computing tasks in a terminal device to reduce the load on the server. For example, the computing task may be stored, by using the WebAssembly (wasm, which is a binary instruction format of a stack-based virtual machine) technology, in a wasm file that is deployed to the terminal device as an algorithm file.

### SUMMARY

The disclosure relates to the field of Internet technologies, and in particular to an authentication method, apparatus and device, and a computer-readable storage medium.

The embodiments of the disclosure provide an authentication method, apparatus and device, and a computer-readable storage medium, which can improve the security in an authentication process, and then can effectively prevent a computing task from being invoked illegally through the authentication method.

A technical solution of the embodiments of the disclosure is implemented as follows.

The embodiments of the disclosure provide an authentication method, which is applied to a terminal, and includes: information to be verified is encrypted according to a first time stamp to obtain a first ciphertext; an authentication request carrying the first ciphertext and the first time stamp is sent to a server; an authentication response corresponding to the authentication request and sent by the server is received, the authentication response carrying a second ciphertext and a second time stamp; and the second ciphertext is decrypted according to the second time stamp to obtain an authentication result of authenticating the information to be verified by the server.

The embodiments of the disclosure provide an authentication method, which is applied to a server, and includes: an authentication request carrying a first ciphertext and a first time stamp and sent by a terminal is received; the first ciphertext is decrypted according to the first time stamp to obtain information to be verified; the information to be verified is verified to obtain an authentication result; the authentication result is encrypted according to the second time stamp to obtain a second ciphertext; and an authentication response carrying the second time stamp and the second ciphertext is sent to the terminal, the authentication response being used for instructing the terminal to obtain the authentication result according to the decrypted second ciphertext.

The embodiments of the disclosure provide an authentication apparatus, which includes a memory storing processor-executable instructions and a processor. The processor is configured to execute the stored processor-executable instructions to perform operations of: encrypting information to be verified according to a first time stamp to obtain a first ciphertext; sending an authentication request carrying the first ciphertext and the first time stamp to a server; receiving an authentication response corresponding to the authentication request and sent by the server, the authentication response carrying a second ciphertext and a second time stamp; and decrypting the second ciphertext according to the second time stamp to obtain an authentication result of authenticating the information to be verified by the server.

### BRIEF DESCRIPTION OF THE DRAWINGS

FIG. 1 is an optional architecture diagram of an authentication system provided by an embodiment of the disclosure.

FIG. 2 is a structure diagram of an authentication device provided by an embodiment of the disclosure.

FIG. 3 is an optional flowchart of an authentication method provided by an embodiment of the disclosure.

FIG. 4 is an optional flowchart of an authentication method provided by an embodiment of the disclosure.

FIG. 5 is an optional flowchart of an authentication method provided by an embodiment of the disclosure.

FIG. 6 is an optional flowchart of an authentication method provided by an embodiment of the disclosure.

FIG. 7 is an optional flowchart of an authentication method provided by an embodiment of the disclosure.

FIG. 8 is an optional flowchart of an authentication method provided by an embodiment of the disclosure.

FIG. 9 is an optional flowchart of an authentication method provided by an embodiment of the disclosure.

FIG. 10 is an optional flowchart of an authentication method provided by an embodiment of the disclosure.

FIG. 11 is an optional flowchart of an authentication method provided by an embodiment of the disclosure.

FIG. 12 is an optional composition structure diagram of an authentication apparatus provided by an embodiment of the disclosure.

FIG. 13 is an optional composition structure diagram of an authentication apparatus provided by an embodiment of the disclosure.

The accompanying drawings, which are incorporated in and constitute a part of this specification, illustrate embodiments consistent with the disclosure and, together with the specification, serve to illustrate the technical solutions of the disclosure.

### DETAILED DESCRIPTION

For making the objectives, technical solutions and advantages of the disclosure clearer, the disclosure will further be described below in combination with the drawings in detail. The described embodiments should not be considered as limits to the disclosure. All other embodiments obtained by those of ordinary skill in the art without creative work shall fall within the scope of protection of the disclosure.

“Some embodiments” involved in the following descriptions describes a subset of all possible embodiments. However, it can be understood that “some embodiments” may be the same subset or different subsets of all the possible embodiments, and may be combined without conflicts.

Term “first/second/third” involved in the following descriptions is only for distinguishing similar objects and does not represent a specific sequence of the objects. It can be understood that “first/second/third” may be interchanged to specific sequences or orders if allowed to implement the embodiments of the disclosure described herein in sequences except the illustrated or described ones.

Unless otherwise defined, all technical and scientific terms in the specification have the same meaning as those skilled in the art, belonging to the disclosure, usually understand. Terms used in the specification are only used for describing the purpose of the embodiments of the disclosure, but not intended to limit the disclosure.

In the case that the computing task is deployed to the terminal device through the algorithm file, because source codes are completely controlled by the terminal device, there is a problem that the computing task is invoked illegally.

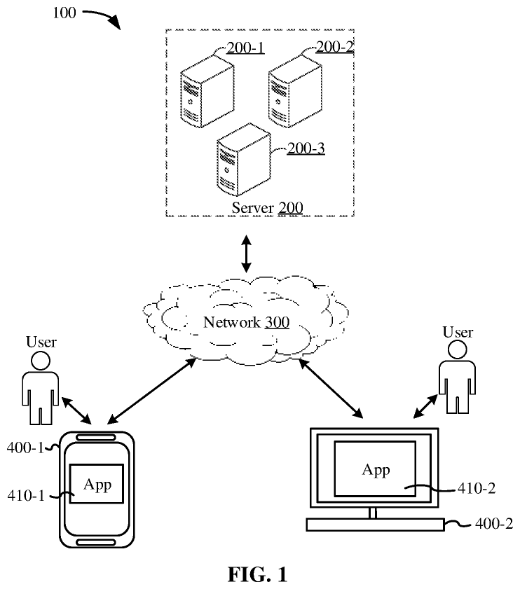

Referring to FIG. 1 which is an optional architecture diagram of an authentication system 100 provided by an embodiment of the disclosure, in order to support an authentication application, a terminal 400 (terminal 400-1 and terminal 400-2 are shown exemplarily) is connected to a server 200 through a network 300, which may be a wide area network or a local area network, or a combination of the two. FIG. 1 also shows that a server 200 may be a server cluster which includes servers 200-1 to 200-3. Similarly, the servers 200-1 to 200-3 may be physical machines or virtual machines built using virtualization technologies (such as a container technology and a virtual machine technology), which is not limited in the embodiments of the disclosure. Of course, a single server may also be used to provide services in the embodiment.

In some possible implementations, after receiving an initialization request for an algorithm file, the terminal 400 encrypts information to be verified according to a first time stamp to obtain a first ciphertext, and sends an authentication request carrying the first ciphertext and the first time stamp to the server 200 connected with the terminal 400; the server 200 decrypts the first ciphertext according to the first time stamp to obtain the information to be verified; the information to be verified is verified to obtain an authentication result; and the authentication result is encrypted according to a second time stamp to obtain a second ciphertext. The server 200 sends an authentication response carrying the second time stamp and the second ciphertext to the terminal 400. The terminal 400 decrypts the second ciphertext according to the second time stamp to obtain the authentication result of authenticating the information to be verified by the server 200, and determines an initialization result of the algorithm file according to the authentication result. The terminal 400 may display the initialization result on a graphical interface 410 (graphical interface 410-1 and graphical interface 410-2 are shown exemplarily).

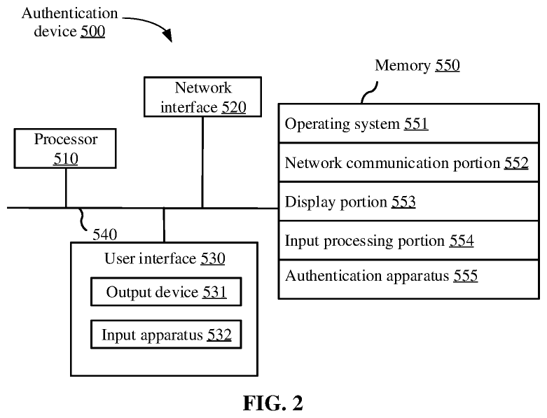

Referring to FIG. 2 which is a structure diagram of an authentication device 500 provided by an embodiment of the disclosure, the authentication device 500 shown in FIG. 2 may include: at least one processor 510, a memory 550, at least one network interface 520 and a user interface 530. Each component in the authentication device 500 is coupled together through a bus system 540. It may be understood that the bus system 540 is configured to implement connection communication among these components. The bus system 540 includes a data bus and further includes a power bus, a control bus and a state signal bus. However, for clear description, various buses in FIG. 2 are marked as the bus system 540.

The processor 510 may be an integrated circuit chip with a signal processing capability, for example, a general-purpose processor, a Digital Signal Processor (DSP), or other programmable logic devices, a discrete gate or transistor logic device, and a discrete hardware component. The general-purpose processor may be a microprocessor or any conventional processor.

The user interface 530 includes one or more output device 531 that can present media contents, including one or more speakers and/or one or more visual display screens. The user interface 530 also includes one or more input apparatus 532, which include user interface components that facilitate user input, such as a keyboard, a mouse, a microphone, a touch screen, a camera, and other input buttons and controls.

The memory 550 includes a volatile memory or a nonvolatile memory, or may include both the volatile and nonvolatile memories. The nonvolatile memory may be a Read Only Memory (ROM). The volatile memory may be a Random Access Memory (RAM). The memory 550 described in the embodiments of the disclosure is intended to include the memory of any proper type. The memory 550 optionally includes one or more storage devices physically located away from the processor 510.

In some possible implementations, the memory 550 can store data to support a variety of operations, examples of which include programs, portions, and data structures, or subsets or supersets thereof, as illustrated below.

An operating system 551 includes system programs configured to process a variety of basic system services and perform a hardware-related task, such as a framework layer, a core library layer and a driver layer, and is configured to implement a variety of basic services and process a hardware-based task.

A network communication portion 552 is configured to reach other computing devices via one or more (wired or wireless) network interfaces 520, which exemplarily include Bluetooth, Wireless Fidelity (WiFi), Universal Serial Bus (USB), etc.

A display portion 553 is configured to present information via one or more output device 531 (such as a display screen and a speaker) associated with the user interface 530 (for example, a user interface for operating a peripheral device and displaying content and information).

An input processing portion 554 is configured to detect one or more user inputs or interactions from one of one or more input apparatus 532 and translate the detected inputs or interactions.

In some possible implementations, an authentication apparatus provided by the embodiments of the disclosure may be realized by combining hardware and software. As an example, the authentication apparatus provided by the embodiments of the disclosure may be a processor in the form of a hardware decoding processor which is programmed to perform an authentication method provided by the embodiments of the disclosure.

In some possible implementations, the authentication apparatus provided by the embodiments of the disclosure may be realized by software. FIG. 2 shows an authentication apparatus 555 stored in the memory 550, which may be software in the form of program and plug-in. In the case that the authentication device is a terminal, the authentication apparatus includes the following portions: a first encrypting portion 1201, a first sending portion 1202, a first receiving portion 1203, and a first decrypting portion 1204. In the case that the authentication device is a server, the authentication apparatus includes the following software portions: a second receiving portion 1301, a second decrypting portion 1302, a verifying portion 1303, a second encrypting portion 1304, and a second sending portion 1305. These portions are logical and therefore may be arbitrarily combined or further split according to functions implemented.

The function of each portion is described below.

In some other embodiments, the apparatus provided by the embodiments of the disclosure may be realized in a hardware manner. As an example, the apparatus provided by the embodiments of the disclosure may be a processor in the form of a hardware decoding processor, which is programmed to perform the authentication method provided by the embodiments of the disclosure. For example, the processor in the form of a hardware decoding processor may use one or more Application Specific Integrated Circuits (ASICs), DSPs, Programmable Logic Devices (PLDs), Complex Programmable Logic Devices (CPLDs), Field-Programmable Gate Arrays (FPGAs) or other electronic components.

In combination with the exemplary application and implementation of the terminal provided by the embodiments of the disclosure, the authentication method provided by the embodiments of the disclosure will be illustrated taking the terminal as the execution body in the embodiments of the disclosure.

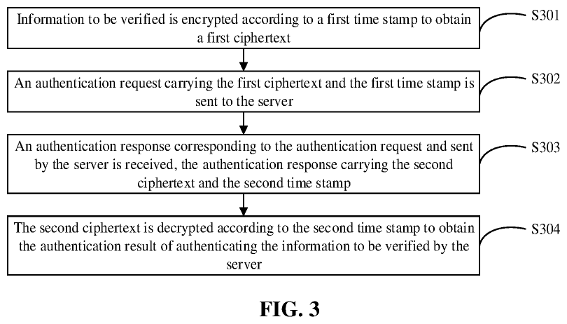

Referring to FIG. 3 which is an optional flowchart of an authentication method provided by an embodiment of the disclosure, the authentication method will be illustrated in combination with steps shown in FIG. 3.

At S301, information to be verified is encrypted according to a first time stamp to obtain a first ciphertext.

In some possible implementations, the terminal may perform the authentication method provided by the embodiments of the disclosure when receiving a request for using a target service. The target service corresponds to at least one algorithm task. When using the target service, the terminal may invoke at least one algorithm task corresponding to the target service. However, before the target service is used, it is needed to verify a permission to use the target service (or a permission to invoke the at least one algorithm task), that is, authenticate the use request. The authentication method provided by the embodiments of the disclosure is performed.

At S301, the first time stamp may be system time when the terminal performs S301, system time when the terminal receives the use request, or system time obtained according to a preset rule. The target services include, but are not limited to, various query services, image recognition services, computing services, etc. Taking that the target service is an image recognition service, when receiving a request for using the image recognition service, the terminal needs to invoke a recognition algorithm task corresponding to the image recognition service. Therefore, in response to the use request, the terminal may authenticate the request for using the image recognition service and perform the authentication method provided by the embodiments of the disclosure. In some possible implementations, the information to be verified may include at least one of: a current domain name, a random check code and an identifier input by a user.

When the information to be verified includes the current domain name, after receiving the use request, the terminal obtains the domain name currently accessed by the terminal (namely the current domain name), and encrypts the current domain name through the first time stamp to obtain the first ciphertext carrying the current domain name When the information to be verified includes the random check code, after receiving the use request, the terminal generates a random check code according to a preset random algorithm, and encrypts the random check code through the first time stamp to obtain the first ciphertext carrying the random check code. The random check code generated is different each time. When the information to be verified includes the identifier input by a user, after receiving the use request, the terminal prompts the user to input the corresponding identifier through an interactive window and receives the identifier, and encrypts the identifier through the first time stamp to obtain the first ciphertext carrying the identifier. The identifier may include, but is not limited to, a password, an account password, etc.

In some possible implementations, the information to be verified may be in the form of “the current domain name+the identifier input by a user”. The current domain name has a corresponding relationship with the identifier, that is, a corresponding relationship between the valid current domain name and the identifier may be pre-stored in the terminal. After obtaining “the current domain name+the identifier input by a user” to be verified corresponding to the current use request, the terminal may detect whether the current use request is valid according to the corresponding relationship between the valid current domain name and the identifier. The corresponding relationship between the valid current domain name and the identifier may also be stored in the server. In this case, a detection method used is the same as that on the terminal.

For example, the corresponding relationship between the valid current domain name and the identifier include the corresponding relationship shown in Table 1 below.

TABLE 1

| | User | User | User | User |
|---|---|---|---|---|
| | identifier 1 | identifier 2 | identifier 3 | identifier 4 |
| Domain name 1 | Valid | Valid | Valid | Valid |
| Domain name 2 | Valid | Invalid | Valid | Invalid |
| Domain name 3 | Invalid | Valid | Invalid | Valid |

If the request for using the target service received by the terminal is “domain name 2+identifier 2”, it is determined that the use request is invalid. If the use request is “domain name 2+identifier 3”, it is determined that the use request is valid. The corresponding relationship between the valid current domain name and the identifier may also be stored in the server, or only in the server or the terminal.

In some possible implementations, when the terminal encrypts the information to be verified to obtain the first ciphertext, an encryption mechanism used is preset, and the encryption mechanism may generate different first ciphertext according to different first time stamps.

In some embodiments, the encryption mechanism may include multiple different encryption methods, each of which corresponds to a period of time. In an encryption process, a target encryption method is selected from multiple different encryption methods according to the period of time of the first time stamp, and the encryption process is completed through the target encryption method. In some embodiments, the encryption mechanism may generate different keys according to different first time stamps, and encryption is completed through the key generated according to the first time stamp.

At S302, an authentication request carrying the first ciphertext and the first time stamp is sent to the server.

In some possible implementations, there is the same encryption mechanism as the terminal pre-stored in the server, correspondingly, there is also a decryption mechanism corresponding to the encryption mechanism pre-stored in the server. When the terminal sends the authentication request to the server, the first time stamp is sent in plaintext. The first ciphertext is encrypted information to be verified.

Because the first time stamp is sent in plaintext, the server may select a target decryption method from multiple different decryption methods according to the period of time of the first time stamp, and complete a decryption process through the target decryption method. The server may also generated different keys according to different first time stamps, and complete decryption through the key generated according to the first time stamp.

In some possible implementations, the authentication request is used for instructing the server to perform the following steps: the first ciphertext is decrypted according to the first time stamp to obtain the information to be verified; the information to be verified is verified to obtain the authentication result; the authentication result is encrypted according to the second time stamp to obtain the second ciphertext; and the authentication response carrying the second time stamp and the second ciphertext is sent to the terminal, the authentication response being used for instructing the terminal to obtain the authentication result according to the decrypted second ciphertext. The server may verify the information to be verified by a white list in which multiple pieces of valid information are pre-stored. When the information to be verified is any one of the multiple pieces of valid information in the white list, the authentication result corresponding to the information to be verified is that authentication is passed. When there is not the information to be verified in the white list, the authentication result corresponding to the information to be verified is that authentication is not passed. For example, when the information to be verified includes “the current domain name+the identifier input by a user”, there may be the white list shown in Table 2 below pre-stored in the server. If the request for using the target service received by the terminal is “domain name 2+identifier 2”, it is determined that the use request is invalid. If the use request is “domain name 2+identifier 3”, it is determined that the use request is valid.

TABLE 2

| White list number | Domain name | User identifier |
|---|---|---|
| 1 | Domain name 1 | User identifier 1 |
| 2 | Domain name 1 | User identifier 2 |
| 3 | Domain name 1 | User identifier 3 |
| 4 | Domain name 2 | User identifier 1 |
| 5 | Domain name 2 | User identifier 3 |
| 6 | Domain name 3 | User identifier 2 |
| . . . | . . . | . . . |

At S303, an authentication response corresponding to the authentication request and sent by the server is received, the authentication response carrying the second ciphertext and the second time stamp.

In some possible implementations, the authentication response sent by the server corresponds to the authentication request sent by the terminal. The authentication request may carry a request identifier which is used for distinguishing different authentication requests. When the terminal needs to send multiple authentication requests at the same time, different request identifiers may be assigned to different authentication requests. Correspondingly, the authentication response also carries the request identifier. By matching the request identifier, the authentication response corresponding to the authentication request may be determined.

In some embodiments, the authentication response carries the second time stamp transmitted in plaintext and the second ciphertext generated by encrypting the authentication result.

At S304, the second ciphertext is decrypted according to the second time stamp to obtain the authentication result of authenticating the information to be verified by the server.

In some possible implementations, the terminal decrypts the second ciphertext according to the second time stamp. The encryption mechanism used is preset, and the encryption mechanism may generate different authentication results according to different first time stamps. The decryption mechanism corresponds to the encryption mechanism in the terminal.

In some embodiments, when the encryption mechanism includes multiple different encryption methods, and each encryption method corresponds to a period of time, the decryption mechanism also includes different decryption methods. The encryption method and the decryption method in each period of time correspond in pairs. In some embodiments, when the encryption mechanism may generate different keys according to different first time stamps, and encryption is completed through the key generated according to the first time stamp, the decryption mechanism may also use the same key generation method to generate different keys according to different first time stamps, and complete the decryption process through the key generated according to the first time stamp.

In some possible implementations, if the decryption is failed, the authentication result is that authentication is failed; if the decryption succeeds, the authentication result of authenticating the information to be verified by the server may be directly obtained.

It can be known from the above exemplary implementation of FIG. 3 in the embodiments of the disclosure that the information to be verified is encrypted according to the first time stamp to obtain the first ciphertext; the authentication request carrying the first ciphertext and the first time stamp is sent to the server; the authentication response corresponding to the authentication request and sent by the server is received, the authentication response carrying the second ciphertext and the second time stamp; and the second ciphertext is decrypted according to the second time stamp to obtain the authentication result of authenticating the information to be verified by the server. In this way, the process of verifying the information to be verified may be performed on the server side, which reduces the computing pressure of the terminal when the terminal is used to perform a complex algorithm task, and the white list used for verifying the information to be verified is maintained by the server, which improves the security of the white list in the authentication process. In addition, the encryption/decryption mechanism provided in the embodiments of the disclosure may also select different encryption/decryption methods according to different time stamps, which further improves the security in the authentication process. The terminal and the server use the same encryption/decryption mechanism, which is easy to deploy and has strong applicability. The authentication method provided by the embodiments of the disclosure may also effectively prevent a computing task from being invoked illegally, thus improving the security of the computing task.

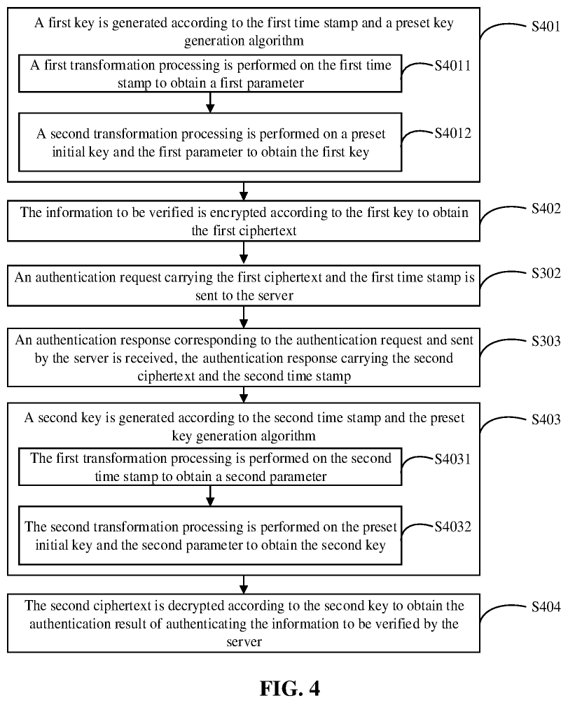

Referring to FIG. 4 which is an optional flowchart of an authentication method provided by an embodiment of the disclosure, based on FIG. 3, S301 in FIG. 3 may be updated to S401 to S402, and S304 may be updated to S403 to S404, and description will be made in combination with the steps shown in FIG. 4.

At S401, a first key is generated according to the first time stamp and a preset key generation algorithm.

In some possible implementations, the key generation algorithm may generate different first keys according to different first time stamps. The key generation algorithm may be implemented through the following solution. At S4011, a first transformation processing is performed on the first time stamp to obtain a first parameter. At S4012, a second transformation processing is performed on a preset initial key and the first parameter to obtain the first key.

The first transformation processing is a character conversion based on the first time stamp. For the same first time stamp, the first parameter obtained by the first transformation processing is also the same. For different first time stamps, the first parameter obtained by the first transformation processing may be different or the same. When the first time stamp includes more than one number from 0 to 9, the first time stamp composed of numbers may be transformed to the first parameter composed of characters according to the character corresponding to each number. The relative positions of multiple numbers in the first time stamp may also be changed according to a preset sequence change rule to obtain the first parameter after the change of the relative positions. A preset value may also be added to each number in the first time stamp to form the first parameter.

For example, if the first time stamp is “20200101”, the first time stamp may be converted to “CACAABAB” according to a preset corresponding relationship “0 corresponds to A, 1 corresponds to B, 2 corresponds to C, and so on”. The relative position of each number in the first time stamp may also be changed, and in the case of reversing, the obtained first parameter is “10100202”. A preset value (for example, 8) may also be added to each number in the first time stamp, and the obtained first parameter is “9898810810” or “98988A8A”.

In some possible implementations, the second transformation processing may generate the first key according to the obtained first parameter and initial key. The second transformation processing may be character processing on each character in the first parameter and each character in the initial key, including but not limited to various replacements, combinations and other character processing modes.

For example, if there is the initial key “ylaQxlGJ”, and the first parameter is “CACAABAB”, the first key may be obtained by combination, such as “ylaQxlGJCACAABAB” and “yClAaCQAxAlBGAJB”. The first key may also be obtained by replacement, such as “ylaQABAB” and “yAaAxBGB”. Replacements, combinations and other character processing modes may also be used at the same time.

At S402, the information to be verified is encrypted according to the first key to obtain the first ciphertext.

At S403, a second key is generated according to the second time stamp and the preset key generation algorithm.

In some possible implementations, the key generation algorithm may generate different second keys according to different second time stamps. The key generation algorithm may be implemented through the following solution. At S4031, the first transformation processing is performed on the second time stamp to obtain a second parameter. At S4032, a second transformation processing is performed on the preset initial key and the second parameter to obtain the second key. The key generation algorithm is the same as that in S401.

At S404, the second ciphertext is decrypted according to the second key to obtain the authentication result of authenticating the information to be verified by the server.

It can be known from the above exemplary implementation of FIG. 4 in the embodiments of the disclosure that, through the preset key generation algorithm, different keys may be generated according to different time stamps, and the security of the transmission of the first ciphertext and the second ciphertext between the terminal and the server may be ensured by encrypting the information to be verified and decrypting the second ciphertext through the keys generated according to the different time stamps. Meanwhile, because different time stamps correspond to different encryption keys, a risk that an unauthorized user cracks the encryption key by hijacking a large amount of transmission ciphertext may be effectively avoided. Meanwhile, because a dynamic key provided in the disclosure is obtained by performing the first transformation processing and the second transformation processing based on the first time stamp, the difficulty for the unauthorized user to crack the key generation algorithm is increased, and the security in the authentication process is further improved.

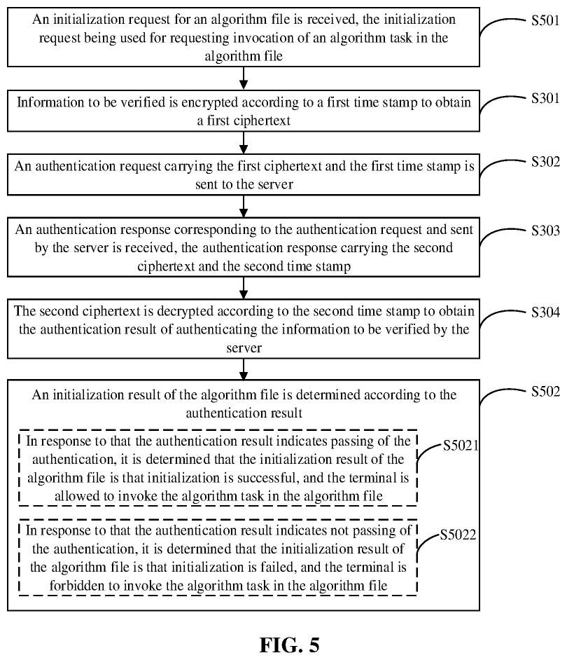

In some possible implementations, referring to FIG. 5 which is an optional flowchart of an authentication method provided by an embodiment of the disclosure, based on FIG. 5, the authentication method may also include S501 before S301, and may also include S502 after S304.

At S501, an initialization request for an algorithm file is received, the initialization request being used for requesting invocation of an algorithm task in the algorithm file.

In some possible implementations, the request for using the target service received by the terminal may be a request for invoking an algorithm task corresponding to the target service. The algorithm task is encapsulated in the algorithm file. When accessing the server corresponding to the target service, the terminal may receive the algorithm file in which a large number of algorithm tasks are encapsulated sent by the server and generate the initialization request for the algorithm file. That is, in order to invoke the algorithm task corresponding to the target service, it is needed to initialize the algorithm file according to the initialization request for the algorithm file first. In the case that the initialization is successful, the terminal may be allowed to invoke all or part of the algorithm tasks in the algorithm file. In the case that the initialization is failed, the terminal is forbidden to invoke the algorithm task in the algorithm file.

After the initialization request for the algorithm file is received, an authentication step provided in FIG. 3 is performed.

At S502, an initialization result of the algorithm file is determined according to the authentication result.

In some possible implementations, S502 may also include: S5021, in response to that the authentication result indicates passing of the authentication, it is determined that the initialization result of the algorithm file is that initialization is successful, and the terminal is allowed to invoke the algorithm task in the algorithm file. Then, the target function is realized.

In some possible implementations, S502 may also include: S5022, in response to that the authentication result indicates not passing of the authentication, it is determined that the initialization result of the algorithm file is that initialization is failed, and the terminal is forbidden to invoke the algorithm task in the algorithm file.

It can be known from the above exemplary implementation of FIG. 5 in the embodiments of the disclosure that by obtaining the initialization request for the algorithm file, obtaining the authentication result transmitted by the server through an encryption channel, and obtaining the initialization result according to the authentication result, the security of the algorithm task in the algorithm file may be ensured, and the unauthorized user is prevented from invoking the algorithm task in the algorithm file.

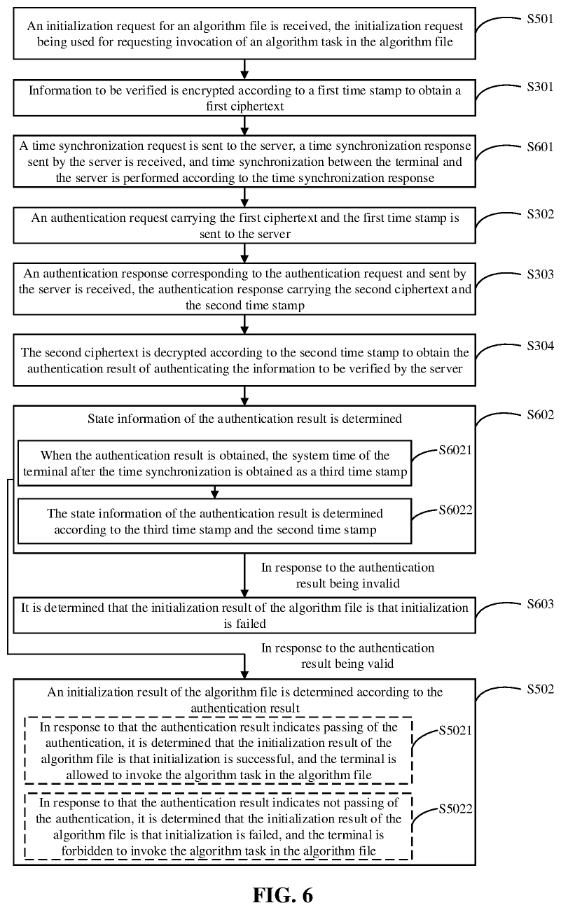

In some possible implementations, referring to FIG. 6 which is an optional flowchart of an authentication method provided by an embodiment of the disclosure, based on FIG. 5, the method may also include S601, S602 and S603.

At S601, a time synchronization request is sent to the server, a time synchronization response sent by the server is received, and time synchronization between the terminal and the server is performed according to the time synchronization response.

In some possible implementations, S601 may be completed in the process of building a connection between the terminal and the server, or executed at any point in time before S302. That is, the purpose of time synchronization is to ensure the validity of the authentication result in the authentication response after the authentication request carrying the first ciphertext is sent. Therefore, in order to ensure the validity of the authentication result, the time synchronization between the terminal and the server may be completed before the authentication request is sent.

At S602, state information of the authentication result is determined.

In the case that the authentication result is invalid, S603 is executed. In the case that the authentication result is valid, S502 is executed.

In some possible implementations, the state information of the authentication result may be determined by the following way. At S6021, when the authentication result is obtained, the system time of the terminal after the time synchronization is obtained as a third time stamp. At S6022, the state information of the authentication result is determined according to the third time stamp and the second time stamp.

S6022 may include that when a time interval between the third time stamp and the second time stamp exceeds a preset valid time threshold, it is determined that the authentication result is invalid; and when the time interval between the third time stamp and the second time stamp does not exceed the valid time threshold, it is determined that the authentication result is valid.

It is to be noted that S6022 may also include that when the time interval between the third time stamp and the second time stamp does not exceed the preset valid time threshold, and the time interval between the third time stamp and the second time stamp exceeds a preset minimum time interval, it is determined that the authentication result is valid. The minimum time interval is related to the quality of a channel between the terminal and the server.

For example, there are the third time stamp T3, the second time stamp T2 and the valid time threshold Th. If (T3−T2)>Th, it is determined that the authentication result is invalid. If (T3−T2)≤Th, it is determined that the authentication result is valid. In another implementation, if (T3−T2)≤Th, it is also needed to determine a relationship with the minimum time interval Tm. If (T3−T2)>Tm, it is determined that the authentication result is valid. If (T3−T2)≤Tm, it is determined that the authentication result is invalid.

At S603, it is determined that the initialization result of the algorithm file is that initialization is failed.

That initialization is failed is used for forbidding the terminal to invoke the algorithm task in the algorithm file.

It can be known from the above exemplary implementation of FIG. 6 in the embodiments of the disclosure that by completing the time synchronization between the terminal and the server before the authentication request is sent, generation time of the authentication result may be determined according to the second time stamp and the third time stamp, and then the validity of the authentication result is determined, which may prevent a replay attack and improve system security.

In combination with the exemplary application and implementation of the terminal provided by the embodiments of the disclosure, the authentication method provided by the embodiments of the disclosure will be illustrated taking the server as the execution body in the embodiments of the disclosure.

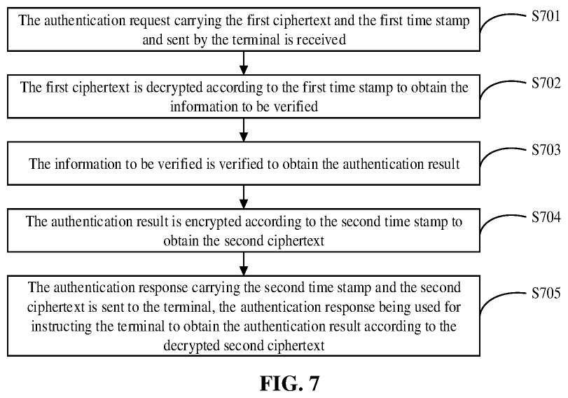

Referring to FIG. 7 which is an optional flowchart of an authentication method provided by an embodiment of the disclosure, the authentication method will be illustrated in combination with steps shown in FIG. 7.

At S701, the authentication request carrying the first ciphertext and the first time stamp and sent by the terminal is received.

In some possible implementations, the first ciphertext is obtained by the terminal encrypting the information to be verified through the preset encryption mechanism. The encryption mechanism may generate different first ciphertext according to different first time stamps. When the terminal sends the authentication request to the server, the first time stamp is sent in plaintext. The first ciphertext is encrypted information to be verified.

At S702, the first ciphertext is decrypted according to the first time stamp to obtain the information to be verified.

In some possible implementations, there is the same encryption mechanism as the terminal pre-stored in the server, correspondingly, there is also a decryption mechanism corresponding to the encryption mechanism pre-stored in the server. The server may decrypt the first ciphertext according to the decryption mechanism to obtain the information to be verified.

In some possible implementations, when the server decrypts the first ciphertext according to the decryption mechanism, if the information to be verified cannot be obtained due to the failure of decryption, it is determined that the authentication result is that authentication is failed.

At S703, the information to be verified is verified to obtain the authentication result.

In some possible implementations, the information to be verified may include at least one of: a current domain name, the random check code and the identifier input by a user.

In some possible implementations, the information to be verified may be in the form of “the current domain name+the identifier input by a user”. The current domain name has a corresponding relationship with the identifier, that is, the corresponding relationship between the valid current domain name and the identifier may be pre-stored in the server through a white list. After obtaining “the current domain name+the identifier input by a user” to be verified, the server may detect whether the current use request is valid according to the corresponding relationship between the valid current domain name and the identifier.

At S704, the authentication result is encrypted according to the second time stamp to obtain the second ciphertext.

In some possible implementations, the second time stamp may be the time when the server receives the authentication request sent by the terminal. The first time stamp may be directly taken as the second time stamp, so as to reduce the computing pressure of the terminal. A server system obtaining the authentication result may be taken as the second time stamp. Based on the same encryption mechanism as the encryption mechanism preset in the terminal, the server may encrypt the authentication result according to the second time stamp to obtain the second ciphertext.

At S705, the authentication response carrying the second time stamp and the second ciphertext is sent to the terminal, the authentication response being used for instructing the terminal to obtain the authentication result according to the decrypted second ciphertext.

In some possible implementations, the authentication response is used for instructing the terminal to perform the following operations: receiving the authentication response corresponding to the authentication request and sent by the server, the authentication response carrying the second ciphertext and the second time stamp; and decrypting the second ciphertext according to the second time stamp to obtain the authentication result of authenticating the information to be verified by the server. The terminal may also execute the following operations: in response to that the authentication result indicates passing of the authentication, determining that the initialization result of the algorithm file is that initialization is successful, and allowing the terminal to invoke the algorithm task in the algorithm file; and in response to that the authentication result indicates not passing of the authentication, determining that the initialization result of the algorithm file is that initialization is failed, and forbidding the terminal from invoking the algorithm task in the algorithm file.

It can be known from the above exemplary implementation of FIG. 7 in the embodiments of the disclosure that the authentication request carrying the first ciphertext and the first time stamp and sent by the terminal is received; the first ciphertext is decrypted according to the first time stamp to obtain information to be verified; the information to be verified is verified to obtain an authentication result; the authentication result is encrypted according to the second time stamp to obtain the second ciphertext; and the authentication response carrying the second time stamp and the second ciphertext is sent to the terminal, the authentication response being used for instructing the terminal to obtain the authentication result according to the decrypted second ciphertext. In this way, the process of verifying the information to be verified may be performed on the server side, which reduces the computing pressure of the terminal when the terminal is used to perform the complex algorithm task. In addition, the encryption/decryption mechanism provided in the embodiments of the disclosure may also select different encryption/decryption methods according to different time stamps, which further improves the security in an authentication process. The terminal and the server use the same encryption/decryption mechanism, which is easy to deploy and has strong applicability.

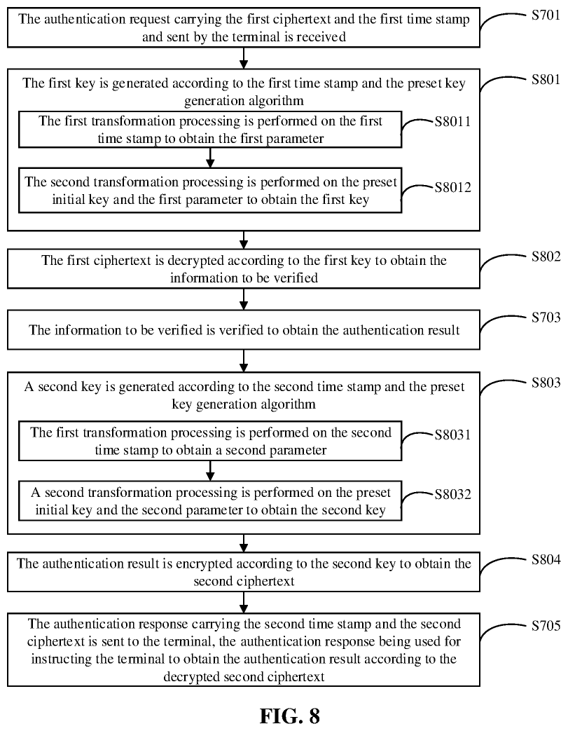

Referring to FIG. 8 which is an optional flowchart of an authentication method provided by an embodiment of the disclosure, based on FIG. 7, S702 in FIG. 7 may be updated to S801 to S802, and S704 may be updated to S803 to S804.

At S801, the first key is generated according to the first time stamp and the preset key generation algorithm.

In some possible implementations, the key generation algorithm may generate different first keys according to different first time stamps. The key generation algorithm may be implemented through the following solution. At S8011, the first transformation processing is performed on the first time stamp to obtain the first parameter. At S8012, the second transformation processing is performed on the preset initial key and the first parameter to obtain the first key. The key generation algorithm is the same as that in S401.

At S802, the first ciphertext is decrypted according to the first key to obtain the information to be verified.

At S803, a second key is generated according to the second time stamp and the preset key generation algorithm.

In some possible implementations, the key generation algorithm may generate different second keys according to different second time stamps. The key generation algorithm may be implemented through the following solution. At S8031, the first transformation processing is performed on the second time stamp to obtain a second parameter. At S8032, a second transformation processing is performed on the preset initial key and the second parameter to obtain the second key. The key generation algorithm is the same as that in S401. The key generation algorithm is the same as that in S401.

At S804, the authentication result is encrypted according to the second key to obtain the second ciphertext.

It can be known from the above exemplary implementation of FIG. 8 in the embodiments of the disclosure, through the preset key generation algorithm, different keys may be generated according to different time stamps, and the security of the transmission of the first ciphertext and the second ciphertext between the terminal and the server may be ensured by encrypting the information to be verified and decrypting the second ciphertext through the keys generated according to the different time stamps. Meanwhile, because different time stamps correspond to different encryption keys, a risk that an unauthorized user cracks the encryption key by hijacking a large amount of transmission ciphertext may be effectively avoided. Meanwhile, because a dynamic key provided in the disclosure is obtained by performing the first transformation processing and the second transformation processing based on the first time stamp, the difficulty for the unauthorized user to crack the key generation algorithm is increased, and the security in the authentication process is further improved.

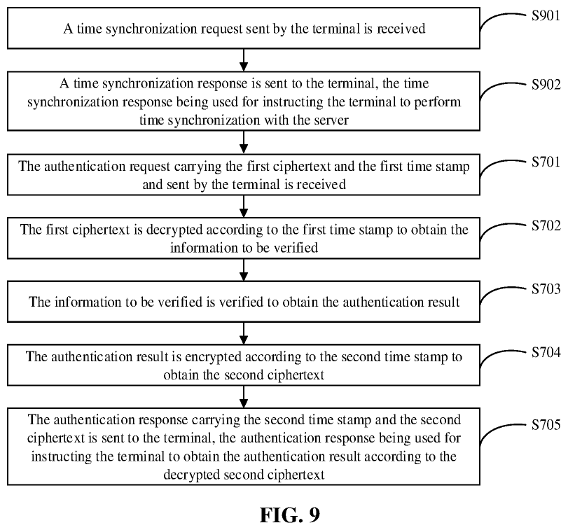

Referring to FIG. 9 which is an optional flowchart of an authentication method provided by an embodiment of the disclosure, based on FIG. 7, before S701, the method may also include S901 to S902.

At S901, a time synchronization request sent by the terminal is received.

At S902, a time synchronization response is sent to the terminal, the time synchronization response being used for instructing the terminal to perform time synchronization with the server.

It can be known from the above exemplary implementation of FIG. 9 in the embodiments of the disclosure that by completing the time synchronization between the terminal and the server before the authentication request is sent, generation time of the authentication result may be determined according to the second time stamp and the third time stamp, and then the validity of the authentication result is determined, which may prevent a replay attack and improve system security.

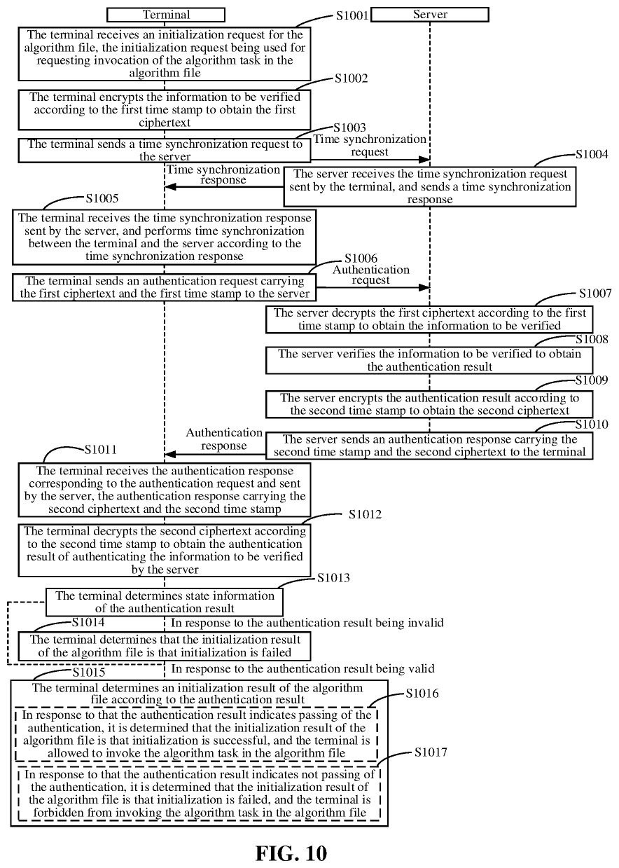

In some possible implementations, referring to FIG. 10 which is an optional flowchart of an authentication method provided by an embodiment of the disclosure, the authentication method will be illustrated in combination with steps shown in FIG. 10.

At S1001, the terminal receives an initialization request for the algorithm file, the initialization request being used for requesting invocation of the algorithm task in the algorithm file.

At S1002, the terminal encrypts the information to be verified according to the first time stamp to obtain the first ciphertext.

At S1003, the terminal sends a time synchronization request to the server.

At S1004, the server receives the time synchronization request sent by the terminal, and the terminal sends a time synchronization response.

At S1005, the terminal receives the time synchronization response sent by the server, and performs time synchronization between the terminal and the server according to the time synchronization response. At this point, the terminal may complete the time synchronization with the server.

At S1006, the terminal sends an authentication request carrying the first ciphertext and the first time stamp to the server.

At S1007, the server decrypts the first ciphertext according to the first time stamp to obtain the information to be verified.

At S1008, the server verifies the information to be verified to obtain the authentication result.

At S1009, the server encrypts the authentication result according to the second time stamp to obtain the second ciphertext.

At S1010, the server sends an authentication response carrying the second time stamp and the second ciphertext to the terminal.

At S1011, the terminal receives the authentication response corresponding to the authentication request and sent by the server, the authentication response carrying the second ciphertext and the second time stamp.

At S1012, the terminal decrypts the second ciphertext according to the second time stamp to obtain the authentication result of authenticating the information to be verified by the server.

At S1013, the terminal determines state information of the authentication result.

In the case that the authentication result is invalid, S1014 is executed. In the case that the authentication result is valid, S1015 is executed.

At S1014, the terminal determines that the initialization result of the algorithm file is that initialization is failed.

At S1015, the terminal determines an initialization result of the algorithm file according to the authentication result.

S1015 includes: S1016, in response to that the authentication result indicates passing of the authentication, it is determined that the initialization result of the algorithm file is that initialization is successful, and the terminal is allowed to invoke the algorithm task in the algorithm file; and S1017, in response to that the authentication result indicates not passing of the authentication, it is determined that the initialization result of the algorithm file is that initialization is failed, and the terminal is forbidden from invoking the algorithm task in the algorithm file.

It can be known from the above exemplary implementation of FIG. 10 in the embodiments of the disclosure that the process of verifying the information to be verified may be performed on the server side, which reduces the computing pressure of the terminal when the terminal is used to perform a complex algorithm task, and the white list used for verifying the information to be verified is maintained by the server, which improves the security of the white list in the authentication process. In addition, the encryption/decryption mechanism provided in the embodiments of the disclosure may also select different encryption/decryption methods according to different time stamps, which further improves the security in the authentication process. The terminal and the server use the same encryption/decryption mechanism, which is easy to deploy and has strong applicability. The authentication method provided by the embodiments of the disclosure may also effectively prevent a computing task from being invoked illegally, thus improving the security of the computing task.

Description on an exemplary application of the embodiments of the disclosure in an actual application scenario will be made below.

The embodiments of the disclosure may solve the problem that the computing task in the algorithm file is invoked illegally. The algorithm file may include, but is not limited to, scripts and modules in various formats. For the convenience of understanding, the authentication method provided by the embodiments of the disclosure is described taking that the algorithm file is a wasm (WebAssembly) file for example.

Wasm is a binary instruction format of a stack-based virtual machine. wasm is designed as a portable compilation target of programming language, accordingly client and server applications may be deployed on a web page. After the algorithm is deployed to the front end through wasm, the source code of wasm is fully under the control of the client, so it can be naturally invoked by the embedded environment where it is. In order to prevent the unauthorized user from invoking algorithm portions (algorithm tasks) in wasm, it is needed to add an authentication portion to improve the security of wasm. At present, for the authentication research on wasm, because the wasm technology is still in the early stage of development, the available authentication methods are limited. A network communication capability of wasm depends on the embedded environment where it is, so tampering with the embedded environment by a third party increases a wasm authentication risk.

In some implementations, an authentication scheme may be implemented by the following method: wasm performs self-authentication first; the current domain name is obtained and it is determined by searching whether the current domain name is in a white list; and handshake authentication is performed, including that: a random check code key is sent to an authorized server and skey2 obtained by encrypting key by the server is obtained; it is determined by comparing whether skey2 is consistent with skey2′ obtained by encrypting key by wasm; and if they are consistent, authentication is passed. A code protection problem in wasm may be solved, but there are still some problems as follows: the size of the white list that can be maintained by the browser is limited; the white list is vulnerable to tampering; it is troublesome to deploy the authorized server, a middleman may hijack a request and forward it to other authorized servers, and as long as the wasm and the authorized server hold the same key, authentication can be passed. To avoid the problem, the keys of wasm and the authorized server need one-to-one correspondence, that is, multiple key schemes are required, so that even if the request is sent to other authorized servers, a response obtained will not be correct.

Therefore, the disclosure provides an authentication method, which may implement remote terminal authentication of wasm based on a javascript (js, which is a function-first lightweight, interpreted or just-in-time compiling programming language) network communication capability, and avoid the risk of js tampering and man-in-middle attack made by the third party. In this way, only the authorized user can successfully invoke an algorithm interface in wasm, which increases the difficulty of third-party attack.

In some possible implementations, an authentication portion is added in a wasm file, before the algorithm interface (algorithm task) is invoked, initialization is performed, and it is determined according to an initialization result whether the algorithm interface can be invoked. During initialization, an authentication request is sent to the server, an authentication result is waited, and it is determined according to the result whether the initialization succeeds. Authentication information is self-obtained and input by a user, and an encryption policy is added to network communication.

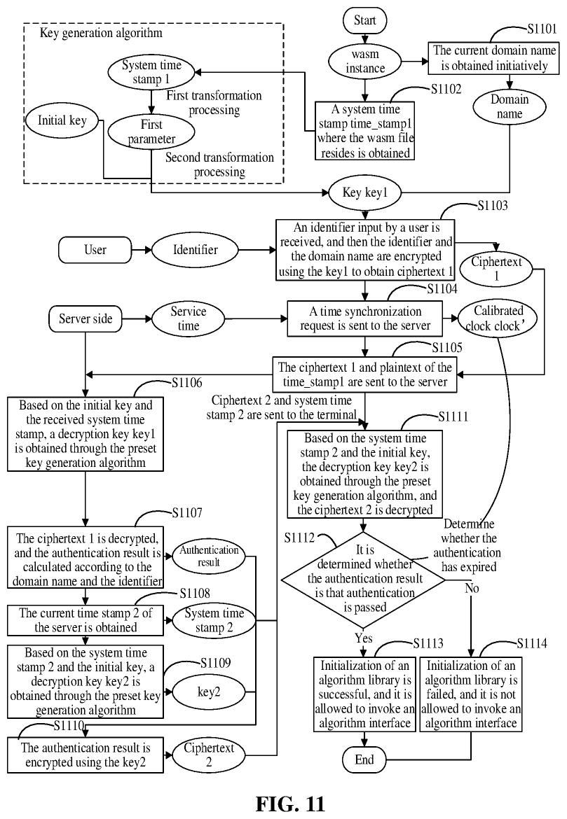

Referring to FIG. 11 which is an optional flowchart of an authentication method provided by an embodiment of the disclosure, the authentication method will be illustrated in combination with steps shown in FIG. 11.

At S1101, the current domain name is obtained initiatively.

At S1102, a system time stamp time_stamp1 where the wasm file resides is obtained, a self-defined first transformation processing is performed on the time_stamp1 to form a first parameter, and then a self-defined second transformation processing is performed on the first parameter and the common initial key initial_key held by the server and wasm to form an encryption key key 1. The process of generating the key1 according to the time_stamp1 and the initial_key may be saved as the preset key generation algorithm. The time_stamp1 is the first time stamp in the above embodiments. The encryption key key1 is the first key in the above embodiments.

At S1103, appID (identifier) input by a user is received, and then the appID and the domain name are encrypted using the key1 to obtain ciphertext 1. The ciphertext 1 is the first ciphertext in the above embodiments.

At S1104, a time synchronization request, which is also encrypted by the same mechanism as S1102 and S1103, is sent to the server together with the time_stamp, after an encryption response of server time is obtained (the mechanism is the same as S1106 to S1110), the server time is recorded and calibrated within wasm to obtain a clock clock′ synchronized with the server.

At S1105, the ciphertext 1 and plaintext of the time_stamp1 are sent to the server.

At S1106, based on the initial_key and the received time_stamp1, the server obtains a decryption key key1 through the preset key generation algorithm.

At S1107, the server decrypts the ciphertext 1, checks whether the appID and the corresponding domain name are in the white list, and records a result as the authentication result.

At S1108, the server obtains the current time stamp time_stamp2. The time_stamp2 is the second time stamp in the above embodiments.

At S1109, based on the time_stamp2 and the initial_key, a decryption key key2 is obtained through the preset key generation algorithm. The key2 is the second key in the above embodiments.

At S1110, the authentication result is encrypted using the key2 to obtain ciphertext 2, and the ciphertext 2 and plaintext of the time_stamp2 are returned to the wasm file. The ciphertext 2 is the second ciphertext in the above embodiments.

At S1111, based on the time_stamp2 and the initial_key in the wasm file, the decryption key key2 is obtained through the preset key generation algorithm, and the ciphertext 2 is decrypted to obtain the authentication result.

At S1112, it is determined whether the authentication result indicates passing of the authentication.

At S1113, if the authentication result indicates not passing of the authentication or decryption is to obtain the authentication result, the initialization is failed.

At S1114, if the authentication result indicates passing of the authentication, wasm queries a calibration clock to obtain the current calibration time time_stamp3, and compares whether the time_stamp3 exceeds a sum of the time_stamp2 and a period of validity; if so, the initialization is failed, or else, the initialization is successful. The time_stamp3 is the third time stamp in the above embodiments.

In some possible implementations, a random check code may be added when wasm communicates with the server, that is, when sending the time synchronization request or authentication ciphertext, wasm may add a random character string which is encrypted by the key and sent to the server, and after decrypting, the server re-encrypts the random character string and returns it with the response, and then wasm verifies whether the random check codes are consistent to determine the validity of the received response. If the random check codes are consistent, the response is valid; or else, the response is invalid. Similarly, the server may also verify the validity of the second request by adding a random check code to the first reply.

Through the authentication method provided by the embodiments of the disclosure, the following technical effects may be achieved: the key changes over time, and it is difficult for a middleman to tamper with the time stamp and ciphertext; it is difficult for a middleman to determine what an authenticated ciphertext is and to use it in the period of validity; because obtaining the domain name is done by the wasm, a code segment is compiled into a bytecode, which does not expose execution steps of the code segment compared with the traditional js code, so it is difficult for a middleman to know what parameters are used for authentication request information; and it is easy to deploy and simple to implement.

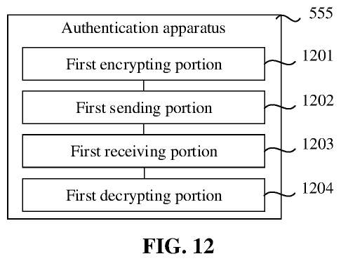

The exemplary structure, implemented as portions, of an authentication apparatus 555 provided by the embodiments of the disclosure is described below. In some possible implementations, as shown in FIG. 12, the portions of the authentication apparatus 555 stored in a memory 550 may include: a first encrypting portion 1201, a first sending portion 1202, a first receiving portion 1203, and a first decrypting portion 1204.

The first encrypting portion 1201 is configured to encrypt the information to be verified according to the first time stamp to obtain the first ciphertext.

The first sending portion 1202 is configured to send the authentication request carrying the first ciphertext and the first time stamp to the server.

The first receiving portion 1203 is configured to receive the authentication response corresponding to the authentication request and sent by the server, the authentication response carrying the second ciphertext and the second time stamp.

The first decrypting portion 1204 is configured to decrypt the second ciphertext according to the second time stamp to obtain the authentication result of authenticating the information to be verified by the server.

In some possible implementations, the first decrypting portion 1201 is further configured to: generate the first key according to the first time stamp and the preset key generation algorithm; and encrypt the information to be verified according to the first key to obtain the first ciphertext.

In some possible implementations, the first encrypting portion 1201 is further configured to: perform the first transformation processing on the first time stamp to obtain the first parameter; and perform the second transformation processing on the preset initial key and the first parameter to obtain the first key.

In some possible implementations, the first decrypting portion 1204 is further configured to: generate the second key according to the second time stamp and the preset key generation algorithm; and decrypt the second ciphertext according to the second key to obtain the authentication result of authenticating the information to be verified by the server.

In some possible implementations, the first decrypting portion 1204 is further configured to: perform the first transformation processing on the second time stamp to obtain the second parameter; and perform the second transformation processing on the preset initial key and the second parameter to obtain the second key.

In some possible implementations, the authentication apparatus 555 may further include an initializing portion, which is configured to receive the initialization request for the algorithm file. The initialization request is used for requesting invocation of the algorithm task in the algorithm file.

In some possible implementations, the authentication apparatus 555 may further include an invoking portion, which is configured to determine the initialization result of the algorithm file according to the authentication result. The invoking portion is further configured to: in response to that the authentication result indicates passing of the authentication, determine that the initialization result of the algorithm file is that initialization is successful, and allow the terminal to invoke the algorithm task in the algorithm file; and in response to that the authentication result indicates not passing of the authentication, determine that the initialization result of the algorithm file is that initialization is failed, and forbid the terminal from invoking the algorithm task in the algorithm file.

In some possible implementations, the authentication apparatus may further include a state determining portion, which is configured to determine the state information of the authentication result, and In response to the authentication result being invalid, determine that the initialization result of the algorithm file is that initialization is failed. The invoking portion is further configured to, in response to the authentication result being valid, determine the initialization result of the algorithm file according to the authentication result.

In some possible implementations, the authentication apparatus 555 may further include a first synchronization portion, which is configured to send the time synchronization request to the server, receive the time synchronization response sent by the server, and perform time synchronization between the terminal and the server according to the time synchronization response. The state determining portion is further configured to: when the authentication result is obtained, obtain the system time of the terminal after the time synchronization as the third time stamp; and determine the state information of the authentication result according to the third time stamp and the second time stamp.

In some possible implementations, the state determining portion is further configured to: when the time interval between the third time stamp and the second time stamp exceeds the preset valid time threshold, determine that the authentication result is invalid; and when the time interval between the third time stamp and the second time stamp does not exceed the valid time threshold, determine that the authentication result is valid.

In some possible implementations, the information to be verified includes at least one of: a current domain name, the random check code and the identifier input by a user.

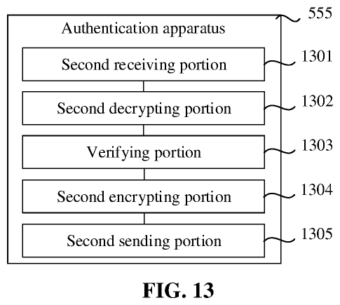

In some possible implementations, as shown in FIG. 13, software portions of the authentication apparatus 555 stored in the memory 550 may include: a second receiving portion 1301, a second decrypting portion 1302, a verifying portion1303, a second encrypting portion 1304 and a second sending portion 1305.

The second receiving portion 1301 is configured to receive the authentication request carrying the first ciphertext and the first time stamp and sent by the terminal.

The second decrypting portion 1302 is configured to decrypt the first ciphertext according to the first time stamp to obtain the information to be verified.

The verifying portion1303 is configured to verify the information to be verified to obtain the authentication result.

The second encrypting portion 1304 is configured to encrypt the authentication result according to the second time stamp to obtain the second ciphertext.

The second sending portion 1305 is configured to send the authentication response carrying the second time stamp and the second ciphertext to the terminal, the authentication response being used for instructing the terminal to obtain the authentication result according to the decrypted second ciphertext.

In some possible implementations, the second decrypting portion 1302 is further configured to: generate the first key according to the first time stamp and the preset key generation algorithm; and decrypt the first ciphertext according to the first key to obtain the information to be verified.

In some possible implementations, the second decrypting portion 1302 is further configured to generate the first key according to the first time stamp and the preset key generation algorithm, which includes: the first transformation processing is performed on the first time stamp to obtain the first parameter; and the second transformation processing is performed on the preset initial key and the first parameter to obtain the first key.

In some possible implementations, the second encrypting portion 1304 is further configured to: generate the second key according to the second time stamp and the preset key generation algorithm; and encrypt the authentication result according to the second key to obtain the second ciphertext.

In some possible implementations, the second encrypting portion 1304 is further configured to: perform the first transformation processing on the second time stamp to obtain the second parameter; and perform the second transformation processing on the preset initial key and the second parameter to obtain the second key.

In some possible implementations, the authentication apparatus 555 may further include a second synchronization portion, which is configured to: receive the time synchronization request sent by the terminal; and send the time synchronization response to the terminal, the time synchronization response being used for instructing the terminal to perform time synchronization with the server.

In some possible implementations, the information to be verified includes at least one of: a current domain name, the random check code and the identifier input by a user.

The embodiments of the disclosure provide a computer program product or a computer program, which may include a computer instruction stored in a computer-readable storage medium. A processor of a computer device reads the computer instruction from the computer-readable storage medium. The processor executes the computer instruction to enable the computer device to perform the authentication method in the embodiments of the disclosure.

The embodiments of the disclosure provide a computer-readable storage medium having stored thereon executable instructions that, when executed by a processor, cause the processor to perform the authentication methods provided by the embodiments of the disclosure, such as the methods shown in FIG. 3, FIG. 4, FIG. 5, FIG. 6, FIG. 7, FIG. 8, FIG. 9, FIG. 10, or FIG. 11.

In some possible implementations, the computer-readable storage medium may be a Ferroelectric Random Access Memory (FRAM), an ROM, a Programmable Read-Only Memory (PROM), an Erasable Programmable Read-Only Memory (EPROM), an Electrically Erasable Programmable Read-Only Memory (EEPROM), a flash memory, a magnetic surface memory, an optical disk, or a Compact Disc Read-Only Memory (CD-ROM), or may be any device including one or any combination of the abovementioned memories.

In some possible implementations, the executable instruction may be compiled according to a programming language of any form (including a compiling or interpretive language, or a declarative or procedural language) in form of a program, software, a software module, a script, or a code, and may be deployed according to any form, including deployed as an independent program or deployed as a module, a component, a subroutine or another unit suitable to be used in a computing environment.

As an example, the executable instruction may but not always correspond to a file in a file system, and may be stored in a part of a file that stores another program or data, for example, stored in one or more scripts in a Hyper Text Markup Language (HTML) document, stored in a single file dedicated to a discussed program, or stored in multiple collaborative files (for example, files storing one or more portions, subprograms or code portions).

As an example, the executable instruction may be deployed in a computing device for execution, or executed in multiple computing devices at the same place, or executed in multiple computing devices that are interconnected through a communication network at multiple places.

The above is only the embodiments of the disclosure and not intended to limit the protection scope of the disclosure. Any modifications, equivalent replacements, improvements and the like within the spirit and scope of the disclosure should fall within the protection scope of the claims of the disclosure.

### INDUSTRIAL APPLICABILITY

The disclosure provides an authentication method, apparatus and device, and a computer-readable storage medium. The method include: information to be verified is encrypted according to a first time stamp to obtain a first ciphertext; an authentication request carrying the first ciphertext and the first time stamp is sent to a server; an authentication response corresponding to the authentication request and sent by the server is received, the authentication response carrying a second ciphertext and a second time stamp; and the second ciphertext is decrypted according to the second time stamp to obtain an authentication result of authenticating the information to be verified by the server. The embodiments of the disclosure can improve the security in an authentication process, and then can effectively prevent computing tasks from being invoked illegally through the authentication method provided by the embodiments.

What is claimed is:

1. An authentication method, applied to a terminal, comprising:
encrypting information to be verified according to a first time stamp to obtain a first ciphertext;
sending an authentication request carrying the first ciphertext and the first time stamp to a server;
receiving an authentication response corresponding to the authentication request and sent by the server, the authentication response carrying a second ciphertext and a second time stamp; and
decrypting the second ciphertext according to the second time stamp to obtain an authentication result of authenticating the information to be verified by the server.

2. The method of claim 1, wherein encrypting the information to be verified according to the first time stamp to obtain the first ciphertext comprises:
generating a first key according to the first time stamp and a preset key generation algorithm; and
encrypting the information to be verified according to the first key to obtain the first ciphertext.

3. The method of claim 2, wherein generating the first key according to the first time stamp and the preset key generation algorithm comprises:
performing a first transformation processing on the first time stamp to obtain a first parameter; and
performing a second transformation processing on a preset initial key and the first parameter to obtain the first key.

4. The method of claim 1, wherein decrypting the second ciphertext according to the second time stamp to obtain the authentication result of authenticating the information to be verified by the server comprises:
generating a second key according to the second time stamp and a preset key generation algorithm; and
decrypting the second ciphertext according to the second key to obtain the authentication result of authenticating the information to be verified by the server.

5. The method of claim 4, wherein generating the second key according to the second time stamp and the preset key generation algorithm comprises:
performing a first transformation processing on the second time stamp to obtain a second parameter; and
performing a second transformation processing on a preset initial key and the second parameter to obtain the second key.

6. The method of claim 1, further comprising: before encrypting the information to be verified according to the first time stamp to obtain the first ciphertext,
receiving an initialization request for an algorithm file, the initialization request being used for requesting invocation of an algorithm task in the algorithm file.

7. The method of claim 1, further comprising:
determining an initialization result of the algorithm file according to the authentication result,
wherein determining the initialization result of the algorithm file according to the authentication result comprises:
in response to that the authentication result indicates passing of the authentication, determining that the initialization result of the algorithm file is that initialization is successful, and allowing the terminal to invoke an algorithm task in the algorithm file;
in response to that the authentication result indicates not passing of the authentication, determining that the initialization result of the algorithm file is that initialization is failed, and forbidding the terminal from invoking the algorithm task in the algorithm file.

8. The method of claim 7, further comprising:
determining state information of the authentication result,
wherein determining the initialization result of the algorithm file according to the authentication result comprises:
in response to the authentication result being valid, determining the initialization result of the algorithm file according to the authentication result.

9. The method of claim 8, further comprising:
sending a time synchronization request to the server, receiving a time synchronization response sent by the server, and performing time synchronization between the terminal and the server according to the time synchronization response,
wherein determining the state information of the authentication result comprises:
when the authentication result is obtained, obtaining system time of the terminal after the time synchronization as a third time stamp; and
determining the state information of the authentication result according to the third time stamp and the second time stamp.

10. The method of claim 9, wherein determining the state information of the authentication result according to the third time stamp and the second time stamp comprises:
when a time interval between the third time stamp and the second time stamp does not exceed a valid time threshold, determining that the authentication result is valid.

11. The method of claim 1, wherein the information to be verified comprises at least one of: a current domain name, a random check code and an identifier input by a user.

12. An authentication method, applied to a server, comprising:
receiving an authentication request carrying a first ciphertext and a first time stamp and sent by a terminal;
decrypting the first ciphertext according to the first time stamp to obtain information to be verified;
verifying the information to be verified to obtain an authentication result;
encrypting the authentication result according to the second time stamp to obtain a second ciphertext; and
sending an authentication response carrying the second time stamp and the second ciphertext to the terminal, the authentication response being used for instructing the terminal to obtain the authentication result according to an decrypted second ciphertext.

13. The method of claim 12, wherein decrypting the first ciphertext according to the first time stamp to obtain the information to be verified comprises:
generating a first key according to the first time stamp and a preset key generation algorithm; and
decrypting the first ciphertext according to the first key to obtain the information to be verified.

14. The method of claim 13, wherein generating the first key according to the first time stamp and the preset key generation algorithm comprises:
performing a first transformation processing on the first time stamp to obtain a first parameter; and
performing a second transformation processing on a preset initial key and the first parameter to obtain the first key.

15. The method of claim 12, wherein encrypting the authentication result according to the second time stamp to obtain the second ciphertext comprises:
generating a second key according to the second time stamp and a preset key generation algorithm; and
encrypting the authentication result according to the second key to obtain the second ciphertext.

16. The method of claim 15, wherein generating the second key according to the second time stamp and the preset key generation algorithm comprises:
performing a first transformation processing on the second time stamp to obtain a second parameter; and
performing a second transformation processing on the preset initial key and the second parameter to obtain the second key.

17. The method of claim 12, further comprising:
receiving a time synchronization request sent by the terminal; and
sending a time synchronization response to the terminal, the time synchronization response being used for instructing the terminal to perform time synchronization with the server.

18. An authentication apparatus, comprising:
a memory storing processor-executable instructions; and
a processor configured to execute the stored processor-executable instructions to perform operations of:
encrypting information to be verified according to a first time stamp to obtain a first ciphertext;
sending an authentication request carrying the first ciphertext and the first time stamp to a server;
receiving an authentication response corresponding to the authentication request and sent by the server, the authentication response carrying a second ciphertext and a second time stamp; and
decrypting the second ciphertext according to the second time stamp to obtain an authentication result of authenticating the information to be verified by the server.

19. An authentication apparatus, comprising:
a memory storing processor-executable instructions; and
a processor configured to execute the stored processor-executable instructions to perform operations of the method of claim 12.

20. A non-transitory computer-readable storage medium having stored thereon computer-readable instructions that, when executed by a processor, cause the processor to implement the method of claim 1.
